(19) United States
(12) Patent Application Publication
(10) Pub. No.: US 2023/0211275 A1
(43) Pub. Date: Jul. 6, 2023

(54) PARALLEL PASSAGE CONTACTOR HAVING ACTIVE LAYERS

(71) Applicant: Svante Inc., Burnaby (CA)

(72) Inventors: Joel CIZERON, Burnaby (CA); Jeffrey ALVAJI, North Vancouver (CA); Kevin Wai Kit LEUNG, Richmond (CA); Sabereh REZAEI, Burnaby (CA); Pierre HOVINGTON, Boucherville (CA)

(21) Appl. No.: 17/927,846

(22) PCT Filed: May 28, 2021
(86) PCT No.: PCT/IB2021/054720

§ 371 Date: Nov. 25, 2022

Related U.S. Application Data
(60) Provisional application No. 63/032,020, filed on May 29, 2020.

(51) Int. Cl. B01D 53/04; B01D 53/88; B01J 20/28; B01J 35/04

(52) U.S. Cl. CPC B01D 53/0407; B01D 53/88; B01J 20/28042; B01J 35/04; B01D 2256/10; B01D 2257/504; B01D 2253/34; B01D 2259/4009; B01D 2255/90

(57) ABSTRACT

The present technology relates generally to parallel passage contactors having active layers and methods for its use. Particularly, the present technology relates to parallel passage contactors having active layers with sorbents and/or catalysts and methods of use in sorptive gas separation and/or catalytic reactions.

### FIELD

Embodiments disclosed herein generally relate to parallel passage contactors and more specifically relates to parallel passage contactors having active layers with sorbents and/or catalysts and methods of use of the same in sorptive gas separation and/or catalytic reactions.

### BACKGROUND

Adsorptive gas separation techniques may be used to separate one or more components from a multi-component fluid mixture. Exemplary applications can include separation of a carbon dioxide component from various fluids such as an air stream, a combustion gas stream, or a process stream, all for reducing the amount of carbon dioxide released into the atmosphere and/or for supplying carbon dioxide for use in a further downstream process or a downstream product.

It may be advantageous to employ an adsorptive gas separator having a reduced pressure drop or a reduced fluid resistance across the separator. In some applications, one or more fluid streams, for example, a feed gas stream, a regeneration fluid stream, or a conditioning fluid stream, may be available at a low pressure, for example, equal to or less than about 1 bar above ambient pressure. In other examples, the costs associated with increasing the pressure of any one of the fluid streams traversing the separator may be expensive or prohibitive. In some applications, a short contact time between the fluid and the sorbent are desired for concentrating or removing a diluted component from the feed gas stream.

Adsorptive gas separators having stationary solid adsorbents are typically configured with packed adsorbent beds or parallel passage contactors. Parallel passage contactors typically have a lower pressure drop relative to packed adsorbent beds and are therefore, better suited for applications where the pressure of a fluid stream supply is limited or the contact time is short (typically less than 1 second). Parallel passage contactors can have one or more adsorbent materials in and/or on an adsorbent support structure, for example, a monolith or layered supports, in the form of active layer or active layers or sheets.

Monoliths are typically made from ceramic materials and have a high heat capacity, which may be undesirable for adsorptive gas separation processes where a rapid swing in temperature, for example, adsorption desorption cycles of less than 5 minutes, is desired. Furthermore, monoliths are typically produced by extruding a slurry through a die having tight tolerances and the production of large monoliths suitable for processing large volumes of gas may be challenging or expensive.

Structured sorbents made of multi-layer active layer or active layers or sheets of adsorbing material have been investigated as parallel passage contactors in a number of applications. An early example is provided in U.S. Pat. No. 4,234,326 where construction of a parallel-flow filter consists of alternate layers of charcoal cloth and air permeable spacing. Further development of layered structured adsorbents for hydrogen purification using rapid PSA (pressure swing adsorption) is described in a number of patents, including U.S. Pat. Nos. 5,082,473; 6,451,095; and 6,692,626, which describe equilibrium-controlled PSA processes that may be enhanced by configuring the adsorbers as layered adsorbent laminate active layers or sheet parallel passage contactor structures, with the adsorbent material formed into adsorbent active layer or active layers, with or without suitable reinforcement materials incorporated into such active layer or active layers. Specific benefits for kinetic selectivity of these structures are discussed in detail in U.S. Pat. No. 7,645,324 where small pore sorbents are used with adsorbing active layers, active layers, or sheets.

Contactors may be configured with a plurality of supports stacked or layered on top of each other, separated by spacers for maintaining a distance and flow passage between the supports. For rapid swing processes where it is desirable to employ a parallel passage contactor having a low heat capacity, supports may be produced from materials having a low heat capacity and thin active layer or active layers or sheets.

U.S. Pat. No. 6,406,523 discloses high surface area parallel passage adsorbers suitable for high frequency operation. The adsorbers comprise layering of thin active layers or sheets for supporting the adsorbent, with spacers between each of the active layers to establish flow channels. The adsorbent active layers comprise adsorbent material coupled to a reinforcement material, for example, a mineral fiber matrix, (such as a glass fiber matrix), a metal wire matrix (such as a wire mesh screen), or a metal foil (such as aluminum foil), which can be anodized. Examples of glass fiber matrices include woven and non-woven glass fiber scrims. The spacers are provided by printing or embossing a raised pattern on each of the adsorbent active sheet, or by placing fabricated spacers between adjacent pairs of adsorbent active layers.

US Patent Publication No. 2002/0170436 A1 discloses adsorbent laminates and methods for making adsorbent laminates, spacers, as well as dimensions of adsorbent structures. Typical disclosed adsorbent laminates have flow channel lengths from about 1 centimeter to about 1 meter, a channel gap height of 50 to 250 microns, and an adsorbent coating thickness of 50 to 300 microns on one or both sides of the active layer. The thickness of the substrate plus applied adsorbent or other materials (such as desiccant, catalyst, etc.) typically ranges from about 10 micrometers to about 500 micrometers.

US Patent Publication No. 2002/0170436A1 also discloses adsorbent sheets in the range of from about 50 to about 400 micrometers thick, channel height between adjacent adsorbent sheets in the range from about 25% to about 200% of the adsorbent sheet thickness, spacers having a thickness or height of about 10 to 250 micrometers, and widths or diameters of the spacers in the millimeter range, such as about 1 to 10 millimeters.

US Patent Publication No. 2004/0118287A1 discloses a parallel passage contactor element with adsorbent sheets, each sheet having a sheet surface area to total sheet volume ratio in the range of 200 to 2500 m²/cm³ and sheet thickness in the range from 50 to 1000 micrometers.

Use of conventional parallel passage contactors for separating a dilute component, for example, less than about 20% by volume, from a gas stream at large volumes have been limited due to higher than desired capital and operating costs. Spacers used to maintain separation between the support structures, sheets or active layers may increase a mechanical strength of a parallel passage contactor but may also increase a pressure drop across the contactor. Increasing the thickness of a support structure or active layer may increase the mechanical strength of a parallel passage contactor but may undesirably increase the heat capacity and volume of the contactor.

A novel parallel passage contactor having a low pressure drop, low heat capacity, and high mechanical strength while enabling manufacturing of large scale contactors at high quantities is desired.

### SUMMARY

Embodiments of a stacked parallel passage contactor structure can comprise a plurality of active layers having sorbents thereon stacked on top of one another, with each of the plurality of active layers being separated by spacers.

In a broad embodiment, a parallel passage contactor comprises a plurality of active layers stacked on top of one another and a plurality of spacers disposed on a surface of each of the plurality of active layers for creating a channel between two adjacently stacked active layers, and creating a plurality of channels for permitting a fluid to flow through the contactor. In embodiments, each channel defines a channel length, a channel width and a channel height, wherein the channel length and channel height between each of said plurality of active layers is at a ratio of 100 to 10,000, and wherein the channel width and channel height between each of said plurality of active layers is at a ratio of 50 to 10,000.

In another broad embodiment, a stack for use in a parallel passage contactor comprises a plurality of active layers stacked on top of one another; and

a plurality of spacers disposed on a surface of each of the plurality of layers for creating a channel between two adjacently stacked active layers, and creating a plurality of channels for permitting a fluid to flow through the stack,

wherein each channel is defined by a channel length, a channel width and a channel height,

wherein said stack has a permeability value of 2,000 to 40,000 Darcy under laminar flow conditions or an average Reynolds number below 1,000, and a flow resistance of said stack induced by said plurality of spacers is equal to or less than 20% of a total flow resistance of said stack.

### BRIEF DESCRIPTION OF THE DRAWINGS

FIG. 1a is a side perspective view of an embodiment of the present invention, illustrating an active layer having an array of cylindrical spacers positioned on a top surface of the active layer;

FIG. 1b is a side view on an embodiment of the present invention, illustrating a plurality of active layers in accordance to FIG. 1a and the alignment of the spacers between each of the plurality of active layers;

FIG. 2 is a perspective view of an embodiment of the present invention, illustrating a stack having a plurality of active layers and a plurality of channels;

FIG. 3 is a perspective view of an embodiment of the present invention illustrating a stack of active layers separated from one another to define a high channel and a low channel;

FIG. 4a is a top view of an embodiment of the present invention illustrating an active layer having spacers with an oblong shape;

FIG. 4b is a top view of a first active layer having spacers with oblong shapes (in accordance to in FIG. 4a) and spacers of a second active layer superimposed over the spacers of the first active layer;

FIG. 4c is a perspective view of an embodiment of the present invention illustrating the active layer and spacers in accordance with FIG. 4b;

FIG. 5a is a photograph of an embodiment of the present invention showing an active layer having spacers having a circular or dot profile or shape, printed on the adsorbent sheet;

FIG. 5b is a photograph of an embodiment of the present invention, showing a plurality of adsorbent sheets and spacers which are printed onto the adsorbent sheets;

FIG. 6a is a photograph of an embodiment of the present invention, showing an active layer having spacers which are printed onto the adsorbent sheet and oblong in shape;

FIG. 6b is a photograph of an embodiment of the present invention showing a plurality of adsorbent sheets or active layers, each of the adsorbent sheets having spacers which are printed onto the adsorbent sheet and oblong in shape;

FIG. 7 is a graph illustrating a plot of a pressure drop measured across an embodiment of the present invention having a channel length of 1 meter; and

FIG. 8 is a graph illustrating plots of a reduction in channel height at a compressive pressure applied in a direction perpendicular to a plane of the active layers of a stack.

FIG. 9 is a process flow diagram of an embodiment of the present invention, illustrating a sorptive gas separation process for separating a first component from a multi-component gas stream using an embodiment stack and a parallel passage contactor.

FIG. 10 is a process flow diagram of an embodiment of the present invention, illustrating a catalytic and sorption process for catalysis of at least a first component from a fluid stream using an embodiment stack and parallel passage contactor.

### DETAILED DESCRIPTION

### Definitions

Substrate: a material for supporting one or more active compounds for example, a sorbent, an adsorbent, an absorbent, and a catalyst. A substrate may take form of a sheet.

Active layer or solid layer: a thin slate, layer or sheet of a porous material, or a composite laminate, containing porous material having a chemical affinity for a specific molecule or atom or ion. In embodiments, an active layer can be use in place of an adsorbent layer, heterogeneous catalyst layer, or a combination of an adsorption and heterogeneous catalysis function layer.

Sheet or laminate: active layer having a thickness less than 1 mm. In embodiments, a sheet can be used as an adsorbent sheet, heterogeneous catalyst sheet, or a combination of an adsorption and heterogeneous function sheet.

Active stack: a plurality of active layers separated by a plurality of spacers inbetween each active layer. In embodiments, the spacers can be positioned on at least a section along a plane of the active layers. In embodiments, an active stack can be used in place of an adsorbent stack, heterogeneous catalysis stack or a combination of an adsorption and heterogeneous catalysis function stack.

Active contactor: one or more active stacks coupled together for having a fluid flow therethrough to contact the active layers.

Adsorbent module or module: active contactor with packaging for restricting the flow of process fluid(s) in a direction other than a direction from an inlet to an outlet. In embodiments, an adsorbent module enables installation of connector or mounting features for integration into a reactor or an adsorption vessel, and in some cases provides mechanical support and pressure bearing envelop for the contactor. In embodiments, the module may have either or both adsorbents and/or catalysts thereon.

Active element: a plurality of active layers separated by a plurality of spacers on at least a section along a plane of the active layers, where the active layers define a plurality of channels, and the channels may have a same or differing channel heights. In embodiments, one or more active elements may be combined and configured to form an active stack.

Spacers: a millimeter scale discreet solid placed between active layers to provide mechanical support to the stack or contactor.

Heat capacity: ratio of an amount of energy required to raise a temperature of the component, such as a physical part of a contactor by a certain temperature before and after application of energy.

Channel: a passage or void within a contactor where one or more process streams flow through.

Channel height: a perpendicular distance between active layers measured from a nearest wetted surfaced of the active layers.

Channel length: a distance between an inlet edge and an outlet edge of a channel.

Channel width: a distance between flow barriers, such as a housing for a contactor in a direction perpendicular to the intended process flow direction and co-planar with the active layers.

Disposed: located on a surface of a material or within the material.

Permeability: ratio of dynamic viscosity by fluid velocity and pressure head loss per unit length (or β).

$$β = \frac{μ Q L}{A Δ p}$$

Laminar flow: flow where fluid particles are mostly following smooth paths in layers with no eddies.

Inlet: structure contactor inlet (also referred to as a stack inlet face) or immediate vicinity to the face from which process fluids enters when in use.

Outlet: structure contactor outlet (also referred to as a stack outlet face) or immediate vicinity to the face from which process fluids exist when in use.

Side(s): structure contactor side (also referred to as stack faces) or immediate vicinity to the face where there is no flow entering or exiting the face.

Middle: any area of the structured contactor that is not in the immediate vicinity to the inlet, outlet or sides.

Area: a contiguous area with at least 10% of the total area of an active layer.

The terms “sorbent”, “adsorbent” and “absorbent” may be used interchangeably herein.

The terms “sorptive”, “adsorptive”, and “absorptive” may be used interchangeably herein.

The terms “catalyst” and “heterogeneous catalyst” may be used interchangeably herein.

### Overall Geometry

Commonly, skilled persons in the art often describe adsorptive contactors using two descriptors for describing the structure thereof: 1) a ratio of channel length (from feed inlet to product outlet) to channel height; and 2) a ratio of channel width to channel height.

The definition of channel length to channel height is driven by practical consideration such as enabling high recovery or conversion of the target molecule or atom separate from the fluid source with maximizing active component utilization. Additionally, contactor geometries with short channels with large entry face area require vessels with large distributor and collector volumes to connect to standard piping. This is undesirable in particular in rapid cycle separation adsorption applications.

The channel width to channel height ratio in contactor designs known in the art is typically significantly smaller than 50, as most physical implementation of multichannel contactors are formed by corrugation or extrusion.

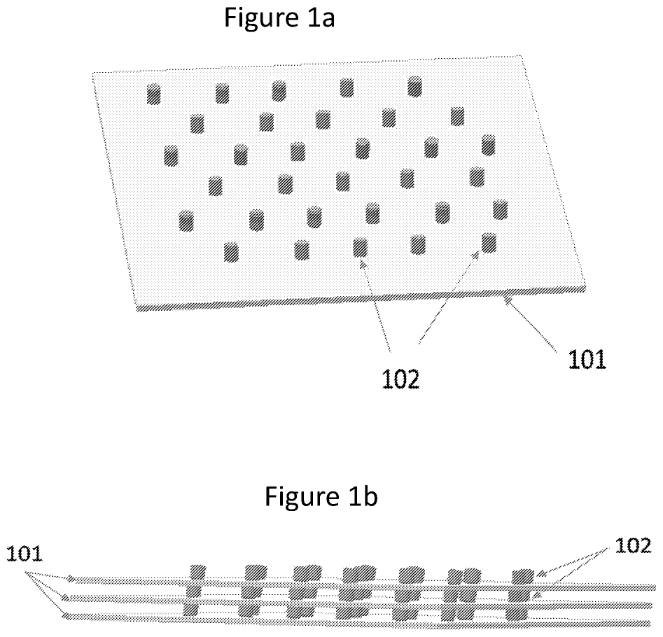

With references to FIGS. 1a and 1b, in embodiments, a structure of the adsorbent contactor generally comprises a plurality of active layers 101 stacked on top of one another in a parallel fashion. Each of the active layers or adsorptive sheets are separated from one another by a plurality of spacers 102, such that the plurality of spacers 102 between each active layer 101 defines or creates a fluid passageway or channel between each of the adsorptive sheets 101. Each of the active layer 101 or adsorptive sheets or laminates can be arranged periodically with an open space in between the solid active layers 101 or sheets.

More specifically, FIGS. 1a and 1b illustrate examples of an active layer 101 with an array or a plurality of spacers 102 on a top surface of an active layer 101. As shown in FIG. 1b, a set of three active layers 101,101, 101 can be assembled in an active stack. As shown, in embodiments, the plurality of spacers 102 between each of the active layers 101 can be arranged in a particular spatial relationship, such that the plurality of spacers 102 are oriented to be positioned vertically on top of one another. In other embodiments, the plurality of spacers 101 can be of another spatial arrangement other than that described or shown in FIG. 1b.

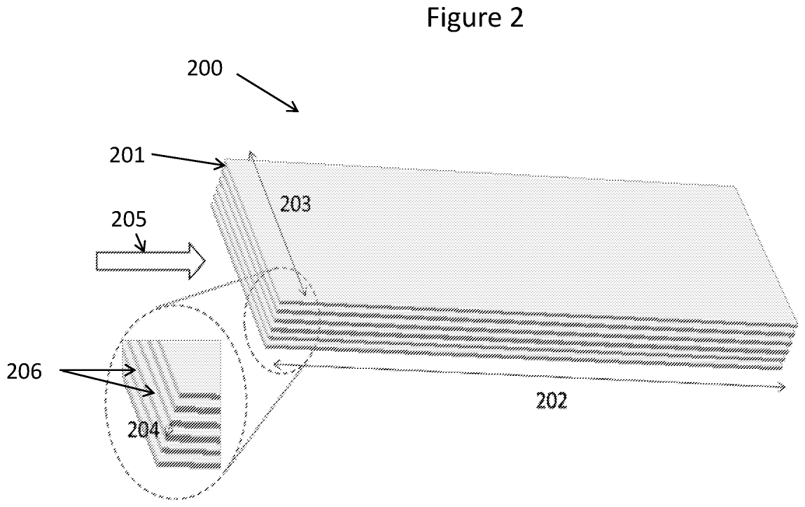

With reference to FIG. 2, embodiments of the present invention can have a contactor 200 having a channel length 202 that is at least 100 times greater than a channel height 204, and can have a channel width 203 that is at least 50 times greater than the channel height 204. Accordingly, this equates to embodiments of the present invention having a ratio of channel length to channel height between the range of 100 and 15,000, while the ratio of channel width to channel height is in the range between 50 and 10,000. Applicants notes that in preferred embodiments the ratio of channel length to channel height is in the range between 100 to 10,000, while the ratio of channel width to channel height is in the range between 50 to 7,000.

More specifically, FIG. 2 shows an active element, a contactor, or a stack 200, having a plurality of active layers 201 being stacked or positioned one on top of another. Each active layer 201, together with an adjacent active layer 201 define or create a flow channel 206 therebetween. As shown, a plurality of flow channels 206 are created by the plurality of active layers 201 in a contactor 200.

Relative to a flow direction 205 of a process fluid, a channel length 202 can be define as a distance between an inlet face and an outlet face or a distance between an inlet and outlet edges of the active layer 201. As shown, the channel length 202 can be the entirety of the length of an active layer.

A channel width 203, can be defined in a direction substantially perpendicular to the flow direction 205. The channel width can be co-planar to the active layer 201 from edge to edge of the active layer 201. As shown, and in embodiments, the channel width 203 is similar to a width of an active layer 201 as fluid movement, diffusion of a component of the process fluid flowing therethrough, or a pressure equilibration is not restricted in the perpendicular direction.

A channel height 204, can be defined as a distance measured between adjacent wetted surfaces of adjacent active layers in a vertical direction perpendicular to a plane of the active layers. Specific ratios of these quantities can be used to describe a desirable geometry for a stack or contactor having high surface area with a low pressure drop between an inlet face and an outlet face.

The spacers 102 disclosed herein can be discreet solid millimeter scale objects separated by a distance of at least 10 channel heights as measured from center of mass to center of mass in a direction parallel to a plane of the supporting active layer or sheet and arranged periodically. In embodiments, a spacer distance between each of the spacers as measured from center of mass to center of mass can be in a range between 10 to 90 times a channel height. The contactor 200 can have a coarse periodic spacer distribution arranged in a periodic array for at least some sections of the contactor 200.

As disclosed above, conventional adsorptive contactors comprise of parallel active layers having a spacers between each of the active layers. Embodiments of the present invention relies on spacers which results in excess of 92% of a volume of the channel between each active layer being open and available to allow or permit fluids to flow therethrough.

Referring back to FIG. 2, and in embodiments, the channel height 204 can be in range between 0.1 mm to 2.0 mm.

In embodiments, the fraction of channel volume to total structure sorbent stack ranges from 15% to 70%.

In embodiments, a surface area of wetted active layer or sheet (two sides of each active layer or sheet) to volume ratio can be in the range between 1000 m²/m³ to 8000 m²/m³.

In embodiments, the adsorbent active layer or sheet stack length can be in the range between 50 mm to 2000 mm (flow length).

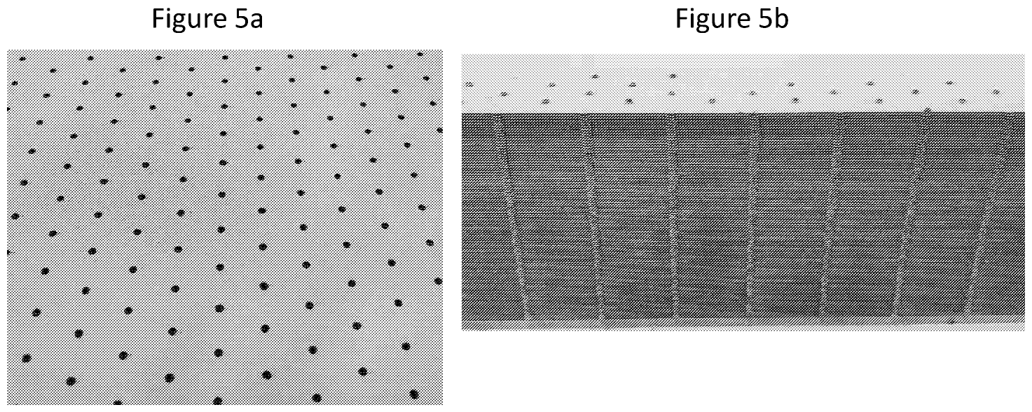

As shown in FIGS. 5a and 5b, an adsorbent sheet or active layer can have a plurality of spacers printed thereon. With specific reference to FIG. 5b, a stack can comprise a plurality of adsorbent sheets stacked on top of one another, with a plurality of spacers separately each active layer from one another and creating a channel allowing fluid to flow therebetween adjacently stacked active layers.

As shown, the plurality of spacers shown in FIGS. 5a and 5b can have a dot shape or profile and can be separated from one another by a spacer distance of about 18 mm. The active layer, as shown in FIGS. 5a and 5b has a thickness of about 0.4 mm. Several hundreds of adsorbent sheets can be stacked while preserving their vertical indexing as shown by the vertical column of dots visible from the stack edge.

In embodiments, a contactor, stack or active layers can be oriented in any direction relative to a gravity vector. However, in embodiments, a vertical co-planar direction with the active layer or active layers or sheets is desirable to enable easier drainage of liquid condensates in gas separation applications.

### Adsorbent Active Layer Characteristics

In embodiments, each adsorbent active layer can be a composite active layer made of fibers, binders and active adsorbent solids. These active layers can also be made of a porous polymer with or without any reinforcing binder or fibers. In embodiments, a characteristic of such embodiments is that is has at least 80% adsorbing solid component by weight.

Sorbent contactors used in the context of thermal swing adsorption or partial pressure swing adsorption processes having large swings in temperature during adsorption or desorption (at least 10° C.), can have one or more active components, for example, a sorbent and/or a catalyst, where a heat capacity of the one or more active component is greater than a heat capacity of the substrate.

In embodiments, the adsorbent in this invention can have a heat capacity greater than 75% of the heat capacity associated with an adsorbing active component or the combined heat capacity of the active component and the substrate. The reduced heat capacity of the substrate and/or overall heat capacity of the contactor relative to its active component loading enables a rapid thermal response to endothermic or exothermic process taking place within the contactor.

In embodiments, the contactor structure in this invention can have a heat capacity greater than 75% of the heat capacity associated with an active component or the combined heat capacity of the active component, the substrate and spacer elements. The reduced heat capacity of the substrate and/or overall heat capacity of the contactor relative to its active component loading enables a rapid thermal response to endothermic or exothermic process taking place within the contactor.

In embodiments, the active layers can be sufficiently strong enough to be manipulated and processed. A porous substrate, impregnated with a slurry, can be heated in an oven, rolled on a receiving roll, transferred to a rotary screen printing tool, printed with spacer dots or lines, cut and stacked. In an embodiment, active layers can be produced by impregnating a porous web or sheet with an adsorbent material suspended in a liquid or slurry of the adsorbent material. Excess slurry can be removed by known methods and the impregnated sheet dried using conventional means. Each dried sheet can then have the plurality of spacers printed, deposited or otherwise disposed thereon. In embodiments, a stencil can be used and spacer ink that can be cured through thermal or UV treatment is applied to the dried sheets to form an active layer. After the printed spacers are cured, the active layer can be cut to size, and then stacked vertically one on top of another and indexed to obtain a vertical alignment of the spacers of each active layer. In embodiments, the stencils can provide the shape of the printed spacers, be it a dot or circular shape, or an oblong or elongated shape.

A tensile strength of the resulting active layer can be greater than 1 N/mm, and more preferably 2 N/mm, and even or more preferably 4 N/mm.

In embodiments, the adsorbent active layer or sheet thickness can be varied from 100 micrometer to 1000 micrometer.

### Flow Resistance Characteristics

In embodiments, a permeability of the structured adsorbent of the present invention can be in the range between 2,000 to 40,000 Darcy for flow corresponding to laminar flow or have a Reynolds numbers below 1,000.

$${Re}_{p} = \frac{ρ {V}_{s} {D}_{p}}{μ ( 1 - ε )}$$

Reynolds number [Function of Viscosity, density, superficial velocity, equivalent diameter, void fraction].

$$β = \frac{μ Q L}{A Δ p}$$

Permeability [Function of viscosity, volumetric flow, flow area, length of flow path, pressure loss]

A spacer height of the structure can be selected after the active layer or sheet thickness is fixed based on desired kinetics for adsorption to achieve high permeability in the specify range above. In embodiments, an advantage of having a small spacer wetted area is inducing less than 20%, or preferably less than 10%, of a total flow resistance for the contactor associated with viscous flow resistance on the surface of those spacers.

### Printing of Spacers and Stacking Spatial Relations Design for Low Pressure Drop and Mechanical Strength

In embodiments, active layers having adsorbent solid or liquid components impregnated or disposed thereon can be assembled into stack of active layers. The stacking of the plurality of active layers creates a plurality of gas flow channels between two adjacently stacked active layers, which can be maintained by placement or positioning periodic arrays of a plurality of spacers between two adjacently stacked active layers. The plurality of spacers can be disposed or printed on at least a portion of one side (or top surface) of each active layer. In embodiments, a spacer projection area or an area of the top surface of an active layer covered by spacers can be between about 1% to about 20%, or preferably about 1% to about 10%, of the planar surface area of the top surface of the active layer.

Additionally, active layers or sheets can be stacked in such a way that the array of a plurality of spacers can be substantially aligned from active layer to an adjacently stacked active layer. Such an arrangement enables the contactor to transfer mechanical load applied perpendicularly to the active layers through the entirety of the contactor or stack, and avoid partial collapse of any of the flow channels created between adjacently stacked active layers when a pressure is applied to the stack.

In an embodiment, a mechanical stiffness of the stack in a perpendicular direction relative the adsorbent active layers can be obtained by overlapping at least 10%, preferably 30%, and more preferably 50%, of a spacer projection area of each active layer when adjacent active layer spacers outline are projected in a direction perpendicular to the active layer or sheet.

In another embodiment, different size and shape spacers can be used in combination to provide both control of inter-active layer spacing and stack compressive load resistance. Spacers, smaller in size, do not require to be aligned precisely from an active layer to another as long as spacers of a larger size carrying the compressive load have a sufficiently large fraction of overlap in their projection in the axis perpendicular to the active layer or sheet.

In another embodiment, adhesive can be applied to atop and/or optionally, to a bottom of the spacer prior to stacking, to further enhance stack mechanical stiffness and resistance to deformation in any direction. This further enhances stack mechanical stiffness and resistance to deformation of the stack. In a further embodiment, more than 20% of the plurality of spacers can have the adhesive applied thereon for increasing mechanical stiffness and resistance to deformation.

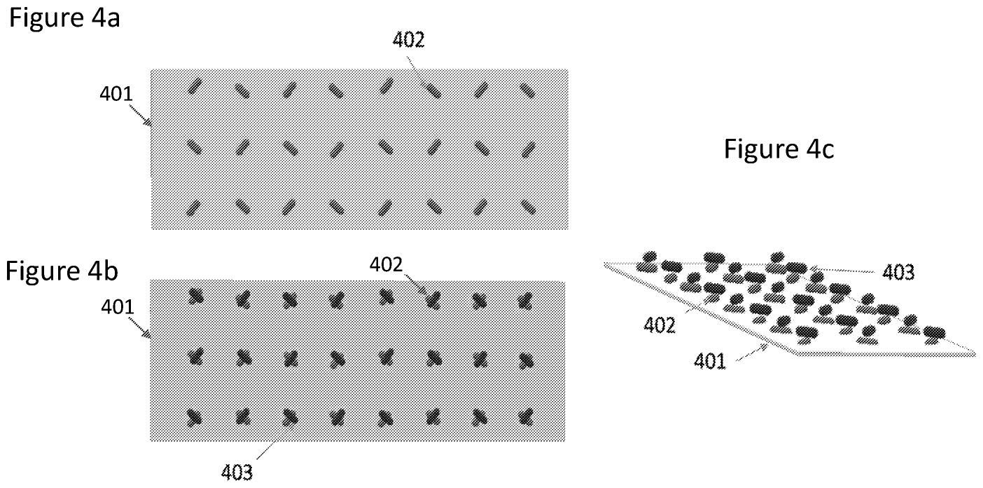

In an embodiment, and with reference to FIGS. 4a to 4c, elongated spacers can have overlapping sections straddling each other with non-over-lapping sections on every side of a stress transfer surface (overlapping projection in tangential direction to the active layer or sheet). In such embodiments, a long axis of an elongated spacer can be oriented or pointed in a different direction, preferably orthogonally between a spacer in mechanical or physical contact through a thin adsorbent active layer or sheet. Preferably, the differently oriented spacers can be disposed, printed or deposited in one periodic pattern, enabling use of a single pattern to build the stack, using an offset from active layer to active layer or sheet.

As shown in FIG. 4a, an active layer 401 can have elongated or oblong shaped spacers 402 deposited or printed thereon. With reference to FIG. 4b, a subsequent active layer 401 having spacers 403 oriented in a different direction can be placed onto the spacer 401 shown in FIG. 4a. Applicant notes that for ease of understanding and reference, Applicant has intentionally omitted the subsequent active layer 401 to allow easier viewing of the overlapping area of the spacers 402 shown in FIG. 4a and the spacers of the subsequent active layer 403.

More specifically, and as shown in FIGS. 4b and 4c, active layer 401 and two periodic array of spacers 402 and spacers 403 have a significant overlap area with non-overlapping area straddling each mechanical contact point. FIG. 4c provides a perspective view of the active layer 401, spacers 402 and spacers 403 which are rotated to show the spatial relation between spacers in a different orientation. Oblong shaped spacers can preferably an aspect ratio of 2 to 6 between their length (or long axis) and width defined within a plane parallel to the active layer.

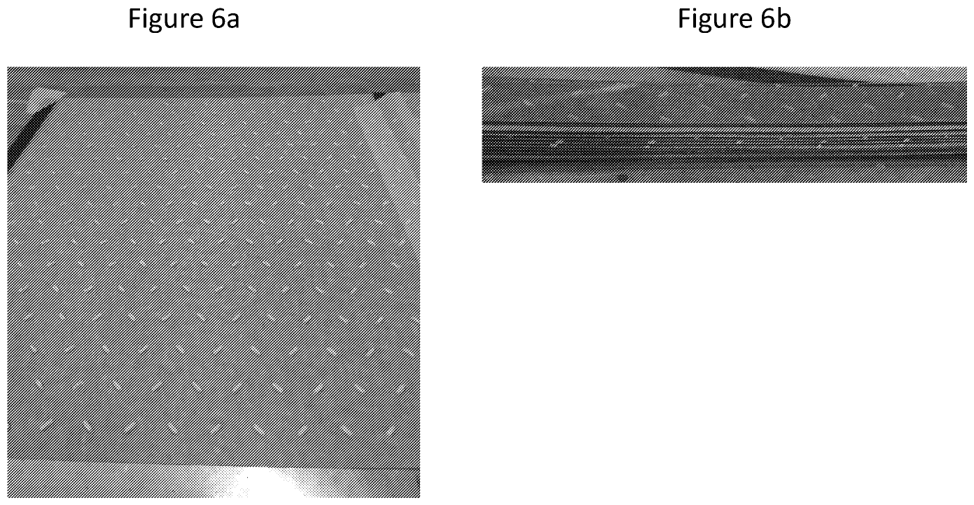

As shown and with reference to FIGS. 6a and 6b, an active layer can have a plurality of spacers printed onto the active layer and be oblong or elongated in shape. In such embodiments, the spacers can be made of silica filled epoxy-resin that is thermally cured. More specifically shown in FIG. 6b, the stack can have a channel spacing of approximately 1 mm after stacking the active layers. Applicant notes that spacers having an oblong shape can be more tolerant of sheet stacking positioning errors than spacers having a cylindrical shape.

The benefit of such arrangement can include minimizing the possibility of the active layers shifting relative to one another, by creating an interlocking feature once pressure is applied to the stack in a direction orthogonal to the active layer or sheet plane.

In embodiments, simple stacking of adsorbent active layers using a uniform periodic arrangement of active layers provides for a contactor where a distribution of channel height has a coefficient of variance (Standard deviation/Average value) in between the range of 1% to 15%. This distribution impacts the flow distribution of a fluid within the stack and average adsorbent saturation at the end of the adsorption step which can be important for high recovery applications. In cases of adsorptive separation applications with greater than 90% capture efficiency target, this feature can become a design requirement.

Surface spacer coverage density of spacers on each of the plurality of spacers can be homogeneously distributed or set differently for different zones.

In embodiments, an area of printed spacers can have different coverage densities as compared to a different area of the active layer. In one embodiment, the spacer coverage density can be 20% to 200% higher near the gas inlet, outlet or sides of the stack than the coverage density in the middle of the stack, for example in the first and last 10% of the bed length in the direction of the flow.

In extreme cases, areas without spacers can be combined with an area with spacers on the same active layer if the active layer is also adapted to accommodate other methods of preserving spacing between adjacently stacked active layers. In an embodiment, one such accommodation can be to apply tensile load or force on the stack (or on each active layer) in at least one direction within the plane of the stack, such as in a direction substantially parallel to the plane of the stack (or each active layer), in order to prevent bending of the unsupported stack (or on each active layer). This strategy can be used in framed plate exchangers on individual active layers. In embodiments, combining spacers to set channel geometry near edges of the active layer with framing and putting a stack under tension is a combination for a structure contactor beds that is advantageous over current technologies used in structured adsorbent contactors. For example, a frame or housing made from a material, for example, metal or a plastic, having a desirable rigidity can be attached along the perimeter of an active layer or a stack of active layers while placing the active layers under a tensile load in a direction substantially along the plane of the active layers.

The combination of using framing and placing the stack under tension enables fine tuning of mechanical properties of the adsorption bed as a function of the stress experienced in a particular area. The inlet, outlet, and edges of stacks that are free standing or not under tension are more likely to develop cracks due to uneven gas velocity distributions than the middle of the active layers. By framing the stacks and placing the stack under tension, the circumferential or perimeter edges of each active layer is less likely to develop cracks as the gas velocity distribution across the channel is more even.

In commercial applications, at least 20 active layers can be stacked with controlled placement of the plurality of spacers on adjacently stacked active layers to form a stack. Assembled stacks may be cut and further stacked on top of one another to form different shaped modules having at least one adsorbent and/or a catalyst. In modules having at least an adsorbent and/or a catalyst, the relative positioning of the plurality of spacers between stacks do not need to be controlled as only a small fraction of the channel in the full assembly will present stacking irregularities.

### Complex Stacking and Multi Stack Arrangements

In embodiments, the simplest stacking of adsorbent active layers is to use a uniform periodic arrangement of active layer or active layers or sheets using a constant channel height as discussed above. However other strategies can be used taking into consideration of maintaining a periodic design with a predictable distribution of fluid flow through the contactor.

In embodiments, two different channel heights between adjacently stacked active layers can be used and repeated periodically. In such embodiments, channels with a greater channel height can drive most of the process flow (2 to 50 times the flow in the narrow channel), while channels with the smaller channel height can be used to improve sorbent loading homogeneity and adsorption/desorption kinetics of the target adsorbate.

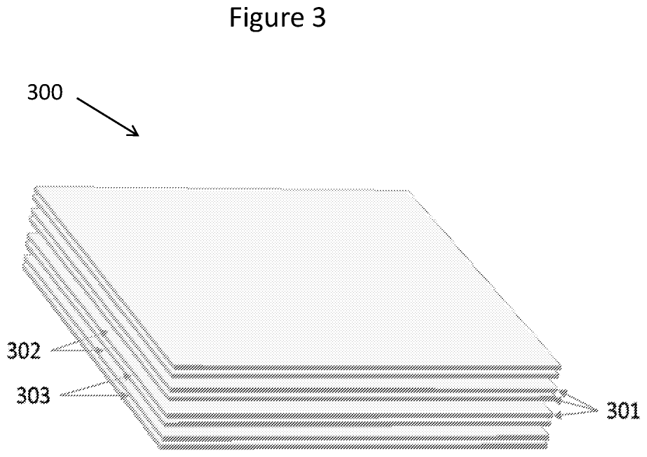

With reference to FIG. 3, a stack can have adjacently stacked active layers defining two different channel heights. As shown, active layers 301 can be arranged in pairs, such that alternate pairs provide for two different channel heights 302, 303. As shown, in an embodiment, two adjacently stacked active layers can be coupled define a pair of active layers having channel height 303, and two pairs of adjacently stacked active layers can be separated by channel height 302. As shown, channel height 302 can be greater than channel height 303.

The benefit of this periodic stacking of two different active layer or active layers or sheets is to reduce ever the overall void fraction of the bed while preserving permeability or increase permeability at constant bed void fraction. In an embodiment, the height of the low channel would be in a range of between 10% to 70% of the height of the high channel. Table 1 illustrates the pressure drop benefits for a constant bed void fraction for a face velocity of 2 m/s.

Table 1 illustrates calculated estimates and comparisons of the relative pressure drop reduction across stacks comprising repeating elements, where elements are configured having a channel A and a channel B, having the same or constant void fraction in either of Example Set 1 or Example Set 2, and having same or varying channel heights. Pressure drop reductions are calculated for a flow rate through the stack or a face velocity of 2 m/s and the stack having active layers with a thickness of 0.254 mm.

TABLE 1

| Channel | Channel | | Channel | | Pressure |
|---|---|---|---|---|---|
| Configuration | heights (mm) | | height ratio | Void | drop |
| (A & B) | A | B | (A/B) | fraction | reduction |

Example Set 1

| | | | | | |
|---|---|---|---|---|---|
| Even height | 0.30 | 0.30 | 1 | 54.50% | Reference 1 |
| dual height | 0.23 | 0.38 | 0.60 | 54.50% | 15.8% |
| dual height | 0.20 | 0.41 | 0.50 | 54.50% | 25.0% |
| dual height | 0.18 | 0.43 | 0.41 | 54.50% | 34.3% |

Example Set 2

| | | | | | |
|---|---|---|---|---|---|
| Even height | 0.38 | 0.38 | 1 | 60% | Reference 2 |
| dual height | 0.30 | 0.46 | 0.67 | 60% | 10.7% |
| dual height | 0.28 | 0.48 | 0.58 | 60% | 17.6% |
| dual height | 0.25 | 0.51 | 0.50 | 60% | 25.0% |

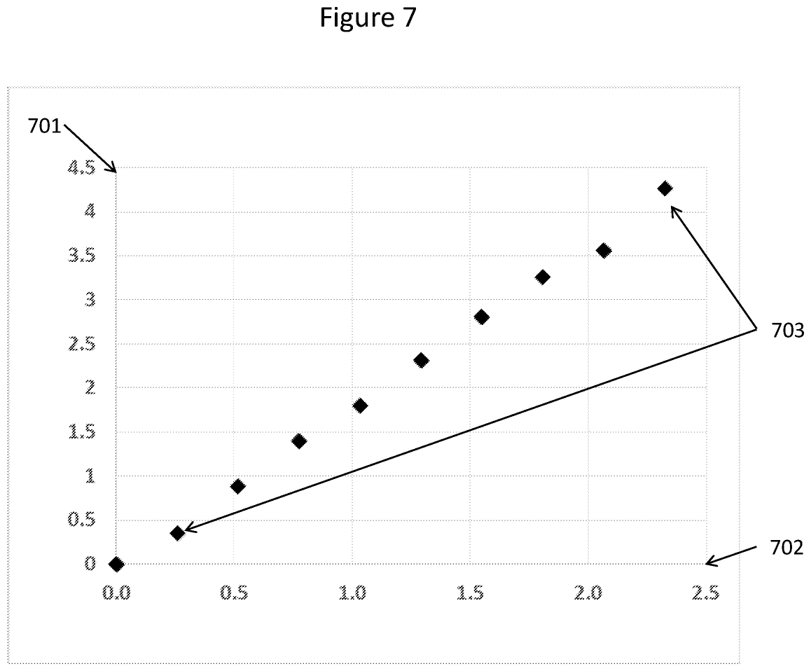

Testing pressure drop characteristics of a stack shown in FIG. 5b was performed after a fraction of the stack was encased or framed on four sides to guide the flow of a gas through the stack along the longitudinal axis of the stack. The gas flow rates were recorded by a mass flow meter, converted to a superficial velocity and tabulated against a measured pressure drop recorded by a pressure transducer. The resulting data is provided in FIG. 7 as plot 703. The Darcy permeability number computed for this stack is about 10,400.

With reference to FIG. 7, a plot 703 of a pressure drop measured across or between an inlet and an outlet of a stack is shown. A y-axis 701 of the graph measures pressure drop in Kilopascals (kPa), while an x-axis 702, of the graph measure a superficial velocity of a nitrogen stream flowing through the channels of the stack in meters per second. The stack comprises a channel length of about 1 m, and the stacked active layers having cylindrical spacers projected an area of about 2% of the area along the plane of the active layer. The pressure drop measurements were taken while flowing nitrogen at ambient temperature and pressure at a superficial velocity of nitrogen. The stack further comprised channels approximately 0.5 mm in height and a 60% void fraction of the channels.

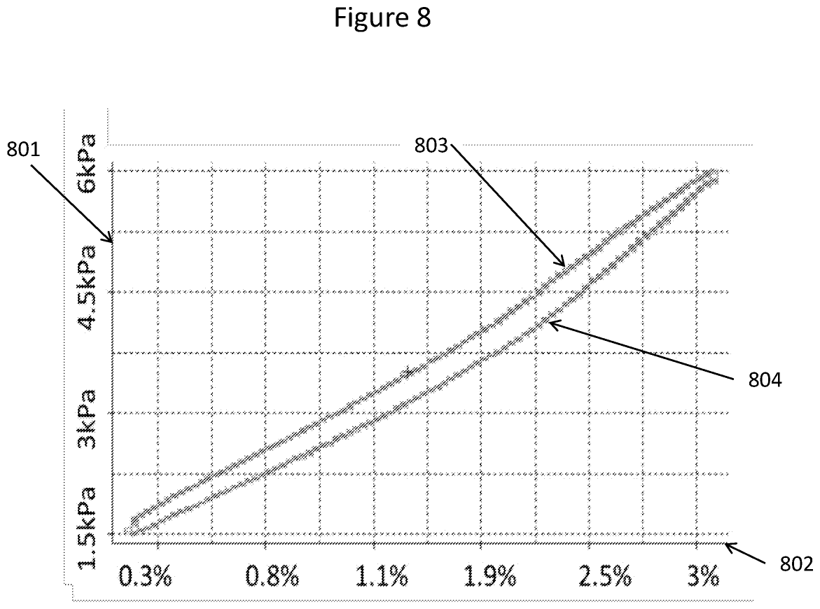

With specific reference to FIG. 8, plots of a channel height reduction at an applied compressive pressure to a stack are illustrated. The y-axis 801 of the graph measures a compressive pressure in Kilopascals (kPa), applied perpendicular to a plane of the active layers of the stack. The x-axis 802 of the graph measures a percentage of channel height reduction. A stack comprising 20 active layers, spacers printed on the active layers and aligned in a direction perpendicular to a plane of the active layers was used. 500 cycles between 1.5 kPa to 6 kPa of applied force was run to determine the plots. Plot 803 and a plot 804 show deformation of the channel in an elastic deformation range of up to 3% channel height reduction. The difference between plot 803 and plot 804 displacement versus force plots comes from the direction of motion as some hysteresis (delay or lag) is observed.

### Mechanical Properties of Adsorbent Stack

In embodiments, the channel height of the structure sorbent retains 96% or greater of its value under a load of 5 kPa applied perpendicularly to the stack.

In a first broad embodiment, a parallel passage contactor comprises a plurality of active layers stacked on top of one another, and a plurality of spacers disposed or deposited on a surface of each of said plurality of layers for creating a channel between two adjacently stacked active layers, and creating a plurality of channels for permitting a fluid to flow through the contactor. Each channel can be defined by a channel length, a channel width and a channel height, wherein said channel length and said channel height of said channel fluid passage between each of said plurality of said active layers is at a ratio of 100 to 10,000, wherein said channel width and said channel height of each said channel fluid passage between said plurality of said active layers is at a ratio of 50 to 10,000, and wherein a spacer projection area of each active layer in a direction perpendicular to a plane of each active layer is between 1% to 20% of a total surface area of each of the active layers.

In another embodiment, the contactor of the first embodiment can further comprise a permeability value of 2,000 to 40,000 Darcy under laminar flow conditions or at an average Reynolds number below 1,000, and a flow resistance of said stack induced by said plurality of spacers is equal to or less than 20% of a total flow resistance of said stack.

In another embodiment, the contactor of the first embodiment can have a substrate with a heat capacity less than a heat capacity of an adsorbing active component impregnated or disposed thereon.

In another embodiment, the contactor of the first embodiment can further comprise a spacer distance in between the range of 10 to 90 times said channel height.

In another embodiment, the plurality of spacers of the first embodiment can be configured in a periodic array within an area of a plane of said active layer.

In another embodiment, the plurality of spacers of the first embodiment can comprise a first spacer having a first size and a first shape, and second spacer having a second size and a second shape, and at least one of: said first size differs from said second size and said first shape differs from said second shape.

In another embodiment, each of the said plurality of spacers of the first embodiment can be elongated in shape having an aspect ratio of 2 to 6.

In another embodiment, the spacer projection area an active layer of the first embodiment can overlap said spacer projection area of another of the plurality of active layers by at least 10%.

In another embodiment, the plurality of spacers can be disposed or deposited on the surface of each of said plurality of spacers having a spacer coverage density. In one embodiment, the spacer coverage density of spacers at one area can be 20% to 200% greater than the spacer coverage density of a different area.

In another embodiment, the contactor of the first embodiment can further comprise means for applying a tensile force to said active layer or said plurality of said active layers in a direction substantially parallel to a plane of said active layer or said plurality of active layers.

In another embodiment, each of the plurality of spacers of the first embodiment can further comprise an adhesive applied thereon.

In another embodiment, the plurality of said active layer of the first embodiment can further comprise a first active layer adjacent to a second active layer, a first active area having a first said plurality of spacers having an elongated shape and forming a first spacer projection area in a direction perpendicular to said first active layer, said second active area having a second said plurality of spacers having an elongated shape and forming a second spacer projection area in a direction substantially perpendicular to said second active layer, where said first spacer projection area and said second spacer projection area partially overlaps and the elongated axis of the spacers whose projected area overlaps is not co-linear.

In another embodiment, the contactor of the first embodiment comprises at least 20 active layers.

In another embodiment, the channels of the first embodiment have a channel height coefficient of variance in the range between 1% to 15%.

In another embodiment, the plurality of channels of the first embodiment can further comprise two differing channel heights, wherein the difference in channel height is in the range between 10% to 70%.

In another embodiment, the contactor of the first embodiment can retain 96% or greater of its channel height when a load of 5 kPa is applied.

In a second broad embodiment, a stack for use in a parallel passage contactor comprises a plurality of active layers stacked on top of one another, and a plurality of spacers disposed or deposited on a surface of each of the plurality of layers for creating a channel between two adjacently stacked active layers, for creating a plurality of channels for permitting a fluid to flow through the stack. In embodiments, each channel can be defined by a channel length, a channel width and a channel height, wherein said stack has a permeability value of 2,000 to 40,000 Darcy under laminar flow conditions or an average Reynolds number below 1,000, and a flow resistance of said stack induced by said plurality of spacers is equal to or less than 20% of a total flow resistance of said stack.

In another embodiment, the stack of the second embodiment can have a heat capacity less than a heat capacity of an adsorbing active component disposed in and/or onto said stack.

In another embodiment, the channel height of the stack of the second embodiment can retain 96% or greater of its channel height when a load of 5 kPa is applied.

### Sorptive Gas Separation Processes Using a Parallel Passage Contactor having Active Layers

In embodiments, a contactor of the present invention can be used in a sorption process for separating a first component from a multi-component gas stream. Embodiments of the contractor or stack can be provided where at least one sorbent material can be disposed in and/or onto a substrate. In embodiments, the at least one sorbent can include, but is not limited to, for example, desiccant, activated carbon, graphite, carbon molecular sieve, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, carbon fiber, carbon nanotube, nano-materials, metal salt adsorbent, perchlorate, oxalate, alkaline earth metal particle, ETS, CTS, metal oxide, supported alkali carbonates, alkali-promoted hydrotalcites, chemisorbent, amine, organo-metallic reactant, a metal organic framework (MOF) adsorbent, a polyethylenimine doped silica (PEIDS) sorbent, an amine containing porous network polymer sorbent, an amine doped porous material sorbent, an amine doped MOF sorbent, a doped activated carbon, a doped graphene, an alkali-doped or rare earth doped porous inorganic sorbent.

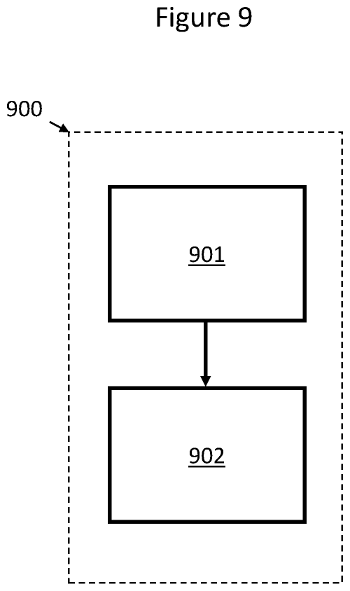

Referring to FIG. 9, in a process embodiment, a sorptive gas separation process 900 for sorptive gas separation of a multi-component fluid mixture or stream comprising at least a first component (which may comprise for example, carbon dioxide, sulfur oxides, nitrogen, oxygen, and/or heavy metals) is provided. In one such embodiment, the sorptive process 900 can separate at least a portion of the first component from the multi-component fluid mixture or stream.

In one aspect, the sorptive gas separation process can employ a parallel passage contactor comprising a plurality of active layers stacked on top of one another, and a plurality of spacers disposed on a surface of each of the plurality of active layers for creating a channel between two adjacently stacked active layers, and creating a plurality of channels for permitting a fluid to flow through the contactor. In embodiments, each channel can have a channel length, a channel width and a channel height, wherein said channel length and said channel height of the channel between each of the plurality of the active layers can be at a ratio of 100 to 10,000. In further embodiments, the channel width and the channel height of each channel between the plurality of the active layers can be at a ratio of 50 to 10,000, and the plurality of spacers covers a spacer projection area of each active layer in a direction perpendicular to a plane of each active layer and have a spacer coverage density between 1% to 20% of a total surface area of each of the active layers.

In another aspect, the sorptive gas separation process can employ a parallel passage contactor comprising a plurality of active layers stacked on top of one another, and a plurality of spacers disposed on a surface of each of the plurality of layers for creating a channel between two adjacently stacked active layers, and creating a plurality of channels for permitting a fluid to flow through the stack, wherein each channel is defined by a channel length, a channel width and a channel height. IN embodiments, the contactor can have a permeability value of 2,000 to 40,000 Darcy under laminar flow conditions or an average Reynolds number below 1,000, and a flow resistance of the contactor induced by the plurality of spacers can be equal to or less than 20% of a total flow resistance of the contactor.

Referring back to FIG. 9, in embodiments of a sorptive gas separation process 900, a parallel passage contactor, as disclosed above, and having at least one sorbent material as an active material, can be provided. A sorbing step 901 followed by a desorbing step 902 can be performed employing such parallel passage contactor, where the sorptive gas separation process 900 can be repeated as desired and optionally contain additional steps (not shown in FIG. 9).

As shown, during sorbing step 901, a multi-component gas stream, containing at least a first component such as carbon dioxide, can be admitted as a feed stream into the parallel passage contactor, or stack, where the feed stream contacts the at least one sorbent material as the feed stream flows through the contactor. As a result, at least a portion of the first component of the feed stream can sorb in and/or onto the sorbent material. Although not specifically shown, the remaining components not sorbed in and/or onto to sorbent material, for example, a second component such as nitrogen, can substantially flow through the contactor and form a first product stream. In embodiments, the first product stream can be depleted in the first component relative to the feed stream. In embodiments, the first product stream can also be enriched in the second component relative to the feed stream. In embodiments, the first product stream can be recovered from the parallel passage contactor or stack.

During desorbing step 902, at least a portion of the first component sorbed in and/or onto the at least one sorbent material can be desorbed, by at least one of a temperature swing mechanism, a pressure swing mechanism, and a partial pressure swing mechanism, to form a second product stream. In embodiments, the second product stream can be enriched in the first component relative to the feed stream. The second product stream can be recovered from the parallel passage contactor or stack. Optionally, a steam stream can be admitted into the parallel passage contactor or stack for desorbing the first component. In embodiments, the steam stream can be recovered from a steam source and admitted into the contactor or stack for desorbing the first component.

### Catalytic Process

In use, embodiments of the contactor can be employed in a catalytic process for catalysis of at least a first component from a fluid stream.

In one aspect, the catalytic process employs a parallel passage contactor comprising a plurality of active layers stacked on top of one another, and a plurality of spacers disposed on a surface of each of the plurality of layers for creating a channel between two adjacently stacked active layers, and creating a plurality of channels for permitting a fluid to flow through the contactor. In embodiments, each channel can be defined by a channel length, a channel width and a channel height, wherein said channel length and said channel height of the channel between each of the plurality of the active layers is at a ratio of 100 to 10,000, and wherein the channel width and the channel height of each channel between the plurality of the active layers is at a ratio of 50 to 10,000. In embodiments, the plurality of spacers can form a spacer projection area of each active layer in a direction perpendicular to a plane of each active layer and can have a spacer coverage density between 1% to 20% of a total surface area of each of the active layers.

In another aspect, the catalytic process can employ a parallel passage contactor comprising a plurality of active layers stacked on top of one another, and a plurality of spacers disposed on a surface of each of the plurality of layers for creating a channel between two adjacently stacked active layers, and creating a plurality of channels for permitting a fluid to flow through the stack, wherein each channel is defined by a channel length, a channel width and a channel height. In embodiments, the contactor can have a permeability value of 2,000 to 40,000 Darcy under laminar flow conditions or an average Reynolds number below 1,000, and a flow resistance of the contactor induced by the plurality of spacers is equal to or less than 20% of a total flow resistance of the contactor.

In an embodiment of the catalytic process, a parallel passage contactor as disclosed above can have at least one catalyst material as an active material.

In a process embodiment, the fluid stream having the first component is admitted as a feed stream into the parallel passage contactor or stack where the feed stream and the first component contacts the at least one catalyst material which catalyzes a reaction to produce a second component. The second component may form a first product stream, which may then be recovered from the parallel passage contactor or stack.

### Catalytic and Sorption Process

In embodiments of, the contactor as disclosed herein, can be used in a catalytic and sorption process for catalysis of at least a first component from a fluid stream. Embodiments of the contactor or stack, can be provided where at least one sorbent material can be disposed in and/or onto the contactor. In embodiments, the at least one sorbent material can be, but is not limited to, for example, desiccant, activated carbon, graphite, carbon molecular sieve, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, carbon fiber, carbon nanotube, nano-materials, metal salt adsorbent, perchlorate, oxalate, alkaline earth metal particle, ETS, CTS, metal oxide, supported alkali carbonates, alkali-promoted hydrotalcites, chemisorbent, amine, organo-metallic reactant, a metal organic framework (MOF) adsorbent, a polyethylenimine doped silica (PEIDS) sorbent, an amine containing porous network polymer sorbent, an amine doped porous material sorbent, an amine doped MOF sorbent, a doped activated carbon, a doped graphene, an alkali-doped or rare earth doped porous inorganic sorbent.

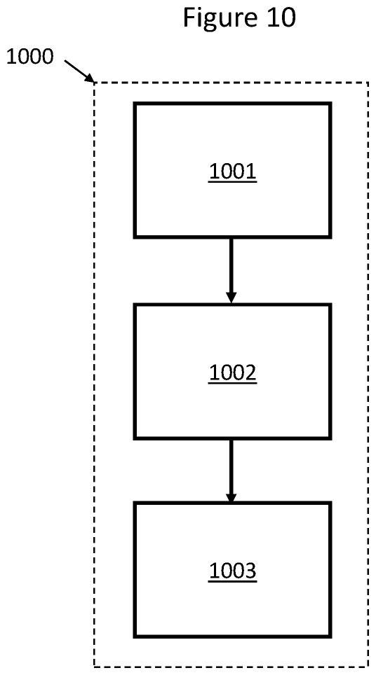

Referring to FIG. 10, in a process embodiment, a catalytic and sorption process 1000 for catalysis of at least a first component from a fluid stream is provided. In one such embodiment, the catalytic and sorption process 1000 can catalyze a reaction to produce a second component.

In one aspect, the catalytic and sorption process can employ a parallel passage contactor comprising a plurality of active layers stacked on top of one another, and a plurality of spacers disposed on a surface of each of the plurality of layers for creating a channel between two adjacently stacked active layers, and creating a plurality of channels for permitting a fluid to flow through the contactor, wherein each channel is defined by a channel length, a channel width and a channel height. In embodiments, said channel length and said channel height of the channel between each of the plurality of the active layers can be at a ratio of 100 to 10,000, and the channel width and the channel height of each channel between the plurality of the active layers can be at a ratio of 50 to 10,000. In embodiments, the plurality of spacers can form a spacer projection area on each active layer in a direction perpendicular to a plane of each active layer and can have a spacer coverage density between 1% to 20% of a total surface area of each of the active layers.

In another aspect, the catalytic and sorption process can employ a parallel passage contactor comprising a plurality of active layers stacked on top of one another, and a plurality of spacers disposed on a surface of each of the plurality of layers for creating a channel between two adjacently stacked active layers, and creating a plurality of channels for permitting a fluid to flow through the stack, wherein each channel is defined by a channel length, a channel width and a channel height. In embodiments, the contactor can have a permeability value of 2,000 to 40,000 Darcy under laminar flow conditions or an average Reynolds number below 1,000, and a flow resistance of the contactor induced by the plurality of spacers is equal to or less than 20% of a total flow resistance of the contactor.

In an embodiment of the catalytic and sorption process, a parallel passage contactor, as disclosed herein and having at least one sorbent material and at least one catalyst material as active materials disposed in and/or onto the contactor, can be performed by employing such parallel passage contactor. The catalytic and sorption process 1000 can be repeated as desired, and optionally, contain additional steps.

In a process embodiment, during a catalyzing step 1001, the fluid stream having the first component can be admitted as a feed stream into the parallel passage contactor, or stack, and flow therethrough. In embodiments, the feed stream and the first component can contact the at least one catalyst material which can catalyzes a reaction to produce at least a second component.

With reference to FIG. 10, during sorbing step 1002, at least one of: at least a portion of the first component, at least a portion of the second component, and at least a portion of a third component, sorbs in and/or onto the at least one sorbent material. In embodiments, a first product stream comprising a product of the reaction and or components not sorbed in and/or onto the contactor can then be recovered from the parallel passage contactor, or stack.

In a process embodiment, during a desorbing step 1003, at least one of: at least a portion of the first component, and at least a portion of a third component can be desorbed from the at least one sorbent material for regenerating the at least one sorbent material. In embodiments, a second product stream, comprising at least one of: at least a portion of the first component, at least a portion of the second component, and at least a portion of a third component, can be recovered from the parallel passage contactor, or stack.

What is claimed is:

1. A parallel passage contactor comprising:
a plurality of active layers stacked on top of one another; and
a plurality of spacers disposed on a surface of each of said plurality of layers for creating a channel between two adjacently stacked active layers, and creating a plurality of channels for permitting a fluid to flow through the contactor,
wherein each channel is defined by a channel length, a channel width and a channel height,
wherein said channel length and said channel height of said channel between each of said plurality of active layers is at a ratio of 100 to 10,000, and
wherein said channel width and said channel height of said channel between said plurality of active layers is at a ratio of 50 to 10,000, and
wherein said plurality of spacers covers a spacer projection area on said active layer in a direction perpendicular to a plane of each active layer, and can have a spacer coverage density between 1% to 20% of a total surface area of each of the active layers.

2. The contactor of claim 1, further comprising a permeability value of 2,000 to 40,000 Darcy under laminar flow conditions or at an average Reynolds number below 1,000, and a flow resistance of said stack induced by said plurality of spacers is equal to or less than 20% of a total flow resistance of said stack.

3. The contactor of claim 1 or 2, further comprising a substrate having a heat capacity less than a heat capacity of an adsorbing active component disposed thereon.

4. The contactor of claim 1, 2 or 3, further comprising a spacer distance in between the range of 10 to 90 times said channel height.

5. The contactor of any one of claims 1 to 4, wherein said plurality of spacers are configured in a periodic array within an area of a plane of said active layer.

6. The contactor of any one of claims 1 to 5, wherein said plurality of spacers can be of different sizes or shapes.

7. The contactor of any one of claims 1 to 6, wherein each of the said plurality of spacers are elongated in shape having an aspect ratio of 2 to 6.

8. The contactor of any one of claims 1 to 7, wherein said spacer projection area of each of said plurality of active layers overlap said spacer projection area of another of the plurality of active layers by at least 10%.

9. The contactor of any one of claims 1 to 8, wherein said spacer coverage density further comprises a plurality of a spacer coverage densities on said active layer.

10. The contactor of claim 9, wherein the spacer coverage density of spacers at one area can be 20% to 200% greater than the spacer coverage density of a different area.

11. The contactor of any one of claims 1 to 10, further comprising means for applying a tensile force to said active layer or said plurality of said active layers in a direction substantially parallel to a plane of said active layer or said plurality of active layers.

12. The contactor of any one of claims 1 to 11, wherein each of the plurality of spacers can further comprise an adhesive applied thereon.

13. The contactor of any one of claims 1 to 12, wherein said plurality of said active layer further comprise a first active layer adjacent to a second active layer, a first active area having a first said plurality of spacers having an elongated shape and forming a first spacer projection area in a direction perpendicular to said first active layer, said second active area having a second said plurality of spacers having an elongated shape and forming a second spacer projection area in a direction substantially perpendicular to said second active layer, where said first spacer projection area and said second spacer projection area partially overlaps and the elongated axis of the spacers whose projected area overlaps is not co-linear.

14. The contactor of any one of claims 1 to 13, wherein said plurality of said active layers is at least 20 layers.

15. The contactor of any one of claims 1 to 14, wherein said plurality of said channels has a channel height coefficient of variance in the range between 1% to 15%.

16. The contactor of any one of claims 1 to 15, wherein the plurality of channels further comprises two differing channel heights, wherein the difference in channel height is in the range between 10% to 70%.

17. The contactor of any one of claims 1 to 16, wherein said channel height retains 96% or greater of said channel height when a load of 5 kPa is applied.

18. A parallel passage contactor comprising:
a plurality of active layers stacked on top of one another; and
a plurality of spacers disposed on a surface of each of the plurality of active layers for creating a channel between two adjacently stacked active layers, and creating a plurality of channels for permitting a fluid to flow through the stack,
wherein each channel is defined by a channel length, a channel width and a channel height,
wherein said stack has a permeability value of 2,000 to 40,000 Darcy under laminar flow conditions or an average Reynolds number below 1,000, and a flow resistance of said stack induced by said plurality of spacers is equal to or less than 20% of a total flow resistance of said stack.

19. The contactor of claim 18, further comprising a substrate having a heat capacity less than a heat capacity of an adsorbing active component disposed in said stack.

20. The contactor of claim 18 or 19, wherein the channel height of said stack retains 96% or greater of said channel height when a load of 5 kPa is applied.

21. A sorption process for separating a first component from a multi-component gas stream, said sorption process comprising:
(a) providing said contactor of any one of claims 1 to 20;
(b) admitting said multi-component gas stream as a feed stream into said contactor;
(c) sorbing at least a portion of said first component from said feed stream on said contactor;
(d) recovering a first product stream enriched in a second component relative to said feed stream from said contactor, and
(e) desorbing at least a portion of said first component sorbed on said contactor.

22. The process of claim 21, wherein said desorbing further comprises desorption by at least one of a temperature swing mechanism, a pressure swing mechanism, and a partial pressure swing mechanism.

23. The process of claim 21 or 22, further comprising admitting a steam stream into said contactor for desorbing said first component during said desorbing step, and recovering a second product stream enriched in said first component relative to said feed stream.

24. The process of claim 21, 22 or 23, wherein said first component further comprises carbon dioxide and said second component further comprises nitrogen.

25. A catalytic process for catalysis of at least a first component from a fluid stream, comprising:
(a) providing said contactor of any one of claims 1 to 20;
(b) admitting said fluid stream having said first component into said contactor;
(c) contacting said first component with said contactor to catalyze a reaction to produce a second component, and
(d) recovering a first product stream comprising said second component.

26. A catalytic and sorption process for catalysis of at least a first component from a fluid stream, comprising:
(a) providing said contactor of any one of claims 1 to 20, wherein said at least one active material further comprising a sorbent material and a catalyst material;
(b) admitting said fluid stream having at least said first component into said contactor;
(c) contacting said first component with a catalyst material disposed on said contactor to catalyze a reaction to produce at least a second component;
(d) sorbing at least one of at least a portion of said first component, at least a portion of said second component, and at least a portion of a third component on said contactor;
(e) recovering a first product stream comprising at least a product from said reaction;
(f) desorbing at least a portion of said first component, or said third component from said sorbent material;
(g) recovering a second product stream comprising at least one of said first component, said second component, and said third component, and
(h) regenerating at least a portion of said sorbent material.
